(19) United States
(12) Patent Application Publication
(10) Pub. No.: US 2007/0248295 A1
(43) Pub. Date: Oct. 25, 2007

(54) Bearing Arrangement

(75) Inventor: John A. Kerr, Derby (GB)

Correspondence Address: OLIFF & BERRIDGE, PLC, P.O. BOX 19928, ALEXANDRIA, VA, 22320, US

(73) Assignee: Rolls-Royce Plc, London (GB)

(21) Appl. No.: 11/665,259

(22) PCT Filed: Oct. 4, 2005
(86) PCT No.: PCT/GB05/03815

§ 371 Date: Apr. 17, 2007

(30) Foreign Application Priority Data
Oct. 30, 2004 (GB) 0424115.4

(51) Int. Cl. F16C 33/66

(52) U.S. Cl. 384/470

(57) ABSTRACT

A bearing arrangement incorporates a cage in order to locate bearings between races. The bearing cage is associated with channels such that oil flow is specifically directed by those channels for oil lubricant control. The channels typically have a central channel which diverges at either end in to channels such that grooves, slots or fluting specifically guides and directs oil flow in order to lubricate opposing surfaces of the arrangement, remove excess lubricant oil and provide a more even oil distribution. In such circumstances higher bearing arrangement performance can be achieved without provision of directed oil feed passages within the arrangement.

The present invention relates to a bearing arrangement and more particularly but not exclusively to bearing arrangements used in aircraft engines.

Bearing arrangements are used in a number of situations and assemblies in order to allow relative rotation or other movement between components such as a shaft within a housing assembly. Aircraft turbine engines are one such situation. Clearly, an objective of bearing arrangements is to allow such movement of rotation with limited friction resistance but proper control of the motion or rotation. An inherent problem with bearing arrangements is that they tend to wear through abrasion such that rotational eccentricities are exacerbated beyond acceptable tolerance levels. In order to reduce wear lubricating oil is used about the bearing arrangement. The lubricating oil flow also provides some cooling of the bearing arrangement.

One particular form of bearing arrangement is that comprising opposed inner and outer race grooves within which ball bearings are captured to allow relative rotation between the components within which the inner and outer race grooves are formed. Furthermore, a cage for the roller elements may also be provided between opposed shoulder surfaces of the respective inner and outer race grooves. The cage essentially separates the roller elements for more efficient operation.

As indicated above, one cause of failure of a bearing arrangement is through wear abrasion, etc. It has been found under low load conditions that there are high levels of cage slip between the cage for the roller elements and the roller elements themselves. The result of such cage slip is high surface slide velocity (skidding) particularly between the inner race groove and roller element contact. Such skidding can result in surface distress and excessive component wear. This problem can be further exacerbated when the cage is piloted, that is to say guided onto the outer race groove or pilot land such that cage rotation is retarded and the pilot land is subject to excessive wear.

In the above circumstances and particularly with regard to high speed bearings, in order to safeguard against such problems as cage lapping (wear of cage piloting land) the cage lands are lubricated by directly feeding oil to them. This is done through specifically drilled oil holes in the piloting lands of the inner race. It will also be understood that direct feeding of oil can be achieved by two dedicated oil jets, one firing directly on each side of the particular piloting lands of the inner cage. Nevertheless, in both cases it may not be possible or extremely difficult due to geometry constraints or lack of oil supply. In the case of a cage oil distributor, loose/surplus oil which has already been fed to the bearing and is entrained within the bearing is then captured by the cage land oil distributor. The distributor then passes this oil out of the piloting surface of the cage and hence provides lubrication. The distributor can also be used to arrest surplus oil in the bearing and eject it from the bearing by again collecting that surplus oil and redirecting it through the cage lands.

In view of the above it will be appreciated that control of lubrication is highly important with respect to achieving best performance. Too little lubrication will cause excessive wear whilst potentially too much lubricant lingering within the bearing may create churning and itself cause heat generation and other problems with respect to bearing operation.

It will also be understood that with regard to upgrading a basic engine or other machine within which the bearing arrangement is located, there is a problem with respect to improving bearing performance without radical re-design of the lubrication system to ensure adequate lubrication is available. Thus, original bearing arrangement performance may constitute a constraint upon easily achievable improvements in base machine or engine operational characteristics.

In accordance with the present invention there is provided a bearing arrangement comprising a bearing cage for rolling elements, the bearing cage separating the rolling elements and driven by those rolling elements, the cage associated with channels for guiding oil flow stimulated by cage driving motion upon the rolling elements for specifically directing that oil flow relative to a facing surface of the cage.

Normally, the channels are formed in a bore surface of the cage.

Typically, the surface channels comprise fluting or grooves or scallops formed in the facing surface of the cage Generally, the cage bore channels incorporate a central channel. Advantageously, end portions of the surface channels diverge from the central channel to facilitate distribution of the oil flow. Typically, such divergence comprises a fish-tail pattern generally symmetrical about the central channel. Advantageously, the channels are provided on both sides of the cage. Possibly, the channels have a variable depth across and/or along their respective length. Generally, the channels are angled to utilize any centrifugal force if the cage is displaced when carried upon the rolling elements. Normally, several individual channels are located side by side in order to form the surface channels. Generally, the bearing cage incorporates pockets to accommodate rolling elements with the channels associated with the interstitial lands, known as cage bars, between such recesses.

Generally, the channels facilitate lubrication of cage guide lands. Additionally, the surface channels remove excess oil from the bearing arrangement about the bearing cage. Additionally, the surface channels provide an even oil distribution for more efficient lubrication.

Generally, the channels are shaped to facilitate oil flow.

Normally, the bearing cage is located between an inner race and an outer race of the bearing arrangement. Generally, the bearing cage is guided by guide lands between the inner race and an opposed surface of the cage.

An embodiment of the present invention will now be described by way of example only and with reference to the accompanying drawings in which;

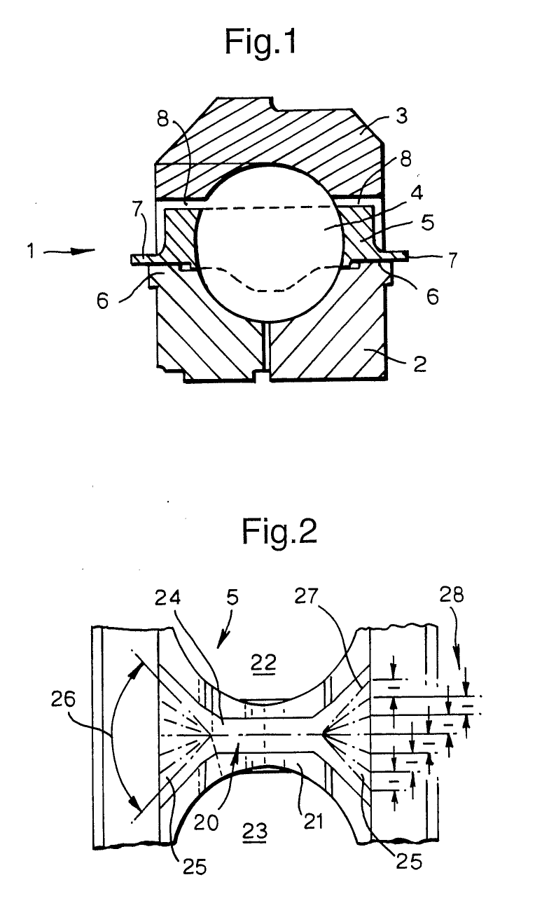

FIG. 1 is a cross-section of a bearing arrangement including an inner race, an outer race and a bearing cage;

FIG. 2 is a plan view of part of a bearing cage in accordance with the present invention;

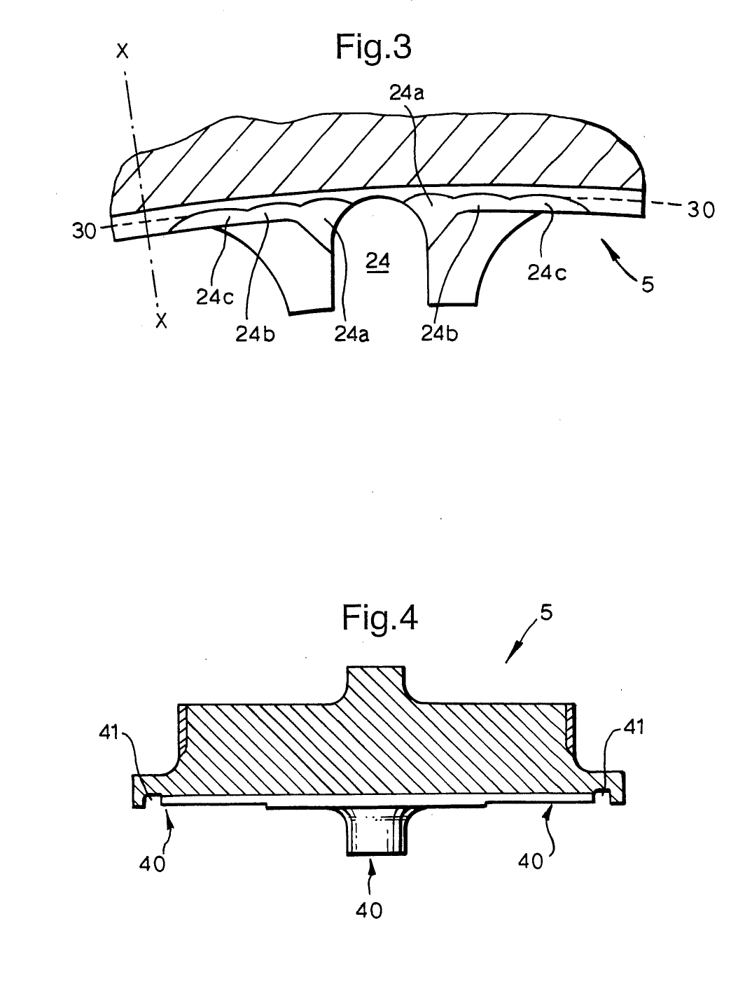

FIG. 3 is a side view of a part of a bearing cage in accordance with the present invention; and,

FIG. 4 is a cross-section of a bearing cage in accordance with the present invention.

As indicated above, bearing arrangements are generally required to facilitate rotation of a shaft or other rotary component. Thus, as illustrated in FIG. 1, a bearing arrangement 1 has an inner race 2 and an outer race 3. Between opposing surface of the races 2, 3, rolling elements are positioned to facilitate rotation. Each rolling element 4 is spaced and separated from other rolling elements by a bearing cage 5, which in addition to spacing the rolling elements for appropriate positioning about and between the races 2,3 also facilitates lubrication.

It will be appreciated that the arrangement 1 is bathed with a lubricating oil such that opposing surfaces between each rolling element 4 and races 2, 3 are appropriately lubricated to avoid premature wear and reduce friction losses. It will be appreciated that a balance must be struck between adequate lubrication to avoid excessive wear and too much lubrication whereby the excess oil will churn and cause heat generation and other operational problems. There is normally a central lubrication fee through a split inner race.

The bearing cage 5 in the embodiment depicted in FIG. 1 is of a so called piloted nature. Thus, guide flats or lands 6, 7 respectively of the inner race 2 and bearing cage 5 act to position the cage 5 relative to the rolling elements 4 in the arrangement 1. Generally, the cage 5 is driven by the rolling elements 4 such that there is a degree of rotation of the cage 5 in order to facilitate lubricant flow about the arrangement 1 in operation. In such circumstances, the opposed lands 6, 7 must also be adequately lubricated to avoid wear of cage lands.

Lubrication is a significant constraint upon operational possibilities with respect to bearing arrangement 1 performance.

It is meeting all the above lubrication requirements which causes a significant problem with respect to any bearing arrangement. As indicated previously, it is known to provide particular oil jet apertures and pathways in order to specifically direct flow through those passages as required for lubrication purposes. Unfortunately such pathways create problems with respect to some arrangements and where higher performance is still required there may be insufficient lubricating oil availability for achieving desired objectives.

With the present invention the bearing cage 5 includes or is associated with channels arranged to collect, distribute, specifically direct and facilitate oil flow. These channels are machined directly into the spacing regions between apertures of the cage within which the rolling elements are located. Normally channels are provided on both sides of the cage to facilitate flow adjacent to the opposing surface of the inner race 2 as well as the outer race 3.

FIG. 2 provides a plan view of a portion of the cage 5 with surface channels 20 machined into a spacer land or cage bar 21 between apertures 22, 23 to accommodate rolling elements (not shown). The surface channels 20 comprise a central channel 24 from which at either side radiant divergent channels 25 extend towards outer edges of the cage 5. The central channel 24 generally comprises a single channel whilst the divergent channels 25 extend outward in a dove-tail format with the channels formed as scallops or grooves or fluting in the surface of the cage 5. The particular shaping of the divergent ends 25 will be chosen in order to achieve the best lubricant oil flow, distribution and presentation within a particular bearing arrangement. Nevertheless, generally the ends 25 as indicated will incorporate machined profiles which radiate about an arc 26 and such that the respective grooves 27 appear to be equally spaced when visually inspected. In any event, it will be understood that the surface channels 20 will be configured and arranged in order to facilitate lubricant flow typically outwards in order to provide appropriate lubrication within an arrangement.

As indicated above, as viewed visually, the grooves 27 will appear to have substantially the same spacing 28. In such circumstances the surface channels formed in the cage 5 act to provide a degree of entrainment for specifically directing oil flow within the arrangement. In such circumstances the surface channels will be particularly chosen and configured in order to provide at least one of the following objectives, lubrication of the cage guide lands, that is to say opposing surfaces 6, 7 and/or remove excess lubricating oil about the rolling elements 4 and/or achieve even oil distribution between opposing surfaces in the bearing arrangement. Thus, the reliability of lubrication will be improved.

It will be appreciated that the surface channels as indicated can be divergent at their ends but also may have a differing width and/or depth along their length again in order to further control and specifically direct oil flow about the arrangement 1.

As shown in FIG. 2 at least the channels 5 at each end will be fluted or grooved or scalloped to direct the oil flow outwardly in the arc 26. In such circumstances the channels may have a slight dip or curvature or be substantially flat. It will also be noted that both sides of the cage, that is to say the side with guide lands 7 and the side 8 opposing the outer race 3 may include surface channels for facilitating along with specifically directing a proportion of lubricating oil flow near to the surface of the piloting land.

The number and distribution of channels as indicated is sufficient to provide reliable lubricating performance in the circumstances required by a particular bearing arrangement 1. In such circumstances the channels may be angled in order to utilize any centrifugal force as the cage 5 is displaced when carried upon the rolling elements 4 in use. Generally, there will be at least two or more channels 25 emanating from the central channel 24 in order to provide specifically directed oil flow as required.

FIG. 3 illustrates a top view of one side of the bearing cage 5. Thus, as can be seen a central channel 24 acts as an oil gallery distributing oils to surface grooves 25 in the form of scallops diverging either side of the channel 24. As can be seen, the depth of each of these scallop channels 24 varies in order that surplus oil is collected in the scallops and then directed along to the outside and onto the cage piloting lands as described previously but not shown in FIG. 3. The inner scallop channels 24a generally are broader and deeper whilst the intermediate scallop channels 24b are of narrower depth and width than the other scallop channels 24a, 24c whilst those outer scallop channels 24c will have broader divergence in comparison with the other scallop channels 24a, 24b in order to provide the necessary oil distribution. However, alternative channel patterns may be used.

As seen from the side, these scallop channels 24 as described previously have a fish-tail surface configuration, that is to say they are substantially flat relative to the circumference line 30 of the cage 5. As indicated previously, a dove-tail format would provide such that these channels 24 curve slightly about and possibly above or below this circumference line 30 again to control oil flow and provide specific direction for that oil flow for lubrication performance.

FIG. 4 illustrates the bearing cage 5 in cross-section outside of the surface channel extremities, that is to say at a position X-X in FIG. 3. Thus, surplus oil inside the bearing arrangement 1 (FIG. 1) is collected in the channel scallops 24 and is then directed by those channel scallops 24 to flow along the outside and on to the cage pilot lands 7 (FIG. 1) for lubrication purposes. Thus, lubricant will be presented at the positions dictated by arrowheads 40 in FIG. 4 and at locations across the cage 5 between gutters 41 for appropriate distribution and presentation of lubricating oil within a bearing arrangement.

As indicated above, it is bearing lubrication reliability which drive the necessity for directed oil feed for lubrication purposes. Typically, below 7000 rpm it is possible to depend upon simple nacent oil flows within the bearing arrangement for adequate cooling, lubrication and operation of the bearing arrangement. However, in excess of 7000 rpm it normally becomes necessary to provide directed oil feed for appropriate lubrication control and cooling. By use of the present invention it is possible to achieve higher rotational speeds without the necessity for directed oil feed channels and passages as described previously which can be difficult to accommodate and will generally require more surplus oil availability.

Although described with respect to provision of the surface channels in the cage itself it would be appreciated that an alternative may be to provide surface channels in the opposed surfaces of the inner or outer race 2, 3. However, these races 2, 3 will normally be static and so any stimulation provided by carriage of the cage 5 upon the rolling elements may be more difficult to utilize.

As described previously, generally a practical bearing arrangement will comprise an inner and outer race with rolling elements located between those races and spaced by a bearing cage. The number of rolling elements and other dimensional factors will depend upon particular operational requirements. Nevertheless, by provision of relatively simple surface machined profiles into the cage 5 bar, the present invention will normally allow higher than expected performance than with previous non directed oil feed lubrication arrangements.

As indicated above, generally the objective of the present invention is to provide for even oil distribution as well as removal of excess oil and lubricate opposing surfaces of the bearing arrangement in such circumstances the channel surfaces will be evenly distributed about the circumference of the cage 5 within which the bearings are spaced and located with the inner and outer race either side.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A bearing arrangement comprising a bearing cage for bearings, the bearing cage spacing the bearings and carried by those bearings, the cage being associated with surface channels for guiding oil flow stimulated by cage carriage upon the bearings for specifically directing that oil flow relative to a facing surface of the cage.

2. An arrangement as claimed in claim 1 wherein the surface channels are formed in the cage.

3. An arrangement as claimed in claim 1 wherein the surface channels comprise fluting or grooves or scallops formed in the facing surface of the cage.

4. An arrangement as claimed in claim 1 wherein the surface channels incorporate a central channel.

5. An arrangement as claimed in claim 1 wherein end portions of the surface channels diverge from the central channel to facilitate distribution of the oil flow.

6. An arrangement as claimed in claim 4 wherein such divergence comprises a fish-tail pattern generally symmetrical about the central channel.

7. An arrangement as claimed in claim 1 wherein surface channels are provided on both sides of the cage.

8. An arrangement as claimed in claim 1 wherein the surface channels have a variable depth across and/or along their respective channels.

9. An arrangement as claimed in claim 1 wherein the surface channels are angled to utilize any centrifugal force if the cage is displaced when carried upon the bearings.

10. An arrangement as claimed in claim 1 wherein several individual channels are located side by side in order to form the surface channels.

11. An arrangement as claimed in claim 1 wherein the bearing cage incorporates recesses to accommodate bearings with the surface channels associated with the interstitial lands between such apertures.

12. An arrangement as claimed in claim 1 wherein the surface channels facilitate lubrication of cage guide lands.

13. An arrangement as claimed in claim 1 wherein the surface channels remove excess oil from the bearing arrangement about the bearing cage.

14. An arrangement as claimed in claim 1 wherein the surface channels provide an even oil distribution for more efficient lubrication.

15. An arrangement as claimed in claim 1 wherein the channels are shaped to facilitate oil flow.

16. An arrangement as claimed in claim 1 wherein the bearing cage is located between an inner and outer race of the bearing arrangement.

17. An arrangement as claimed in claim 1 wherein the bearing cage is guided by guide lands between at least one of the inner or the outer race and an opposed surface of the cage.

18. A turbine engine incorporating a bearing arrangement as claimed in claim 1.
